(19) United States
(12) Patent Application Publication
(10) Pub. No.: US 2025/0244780 A1
(43) Pub. Date: Jul. 31, 2025

(54) COOLING METHOD AND PRODUCTION SYSTEM

(71) Applicants: TRUMPF Werkzeugmaschinen SE + Co. KG, Ditzingen (DE); Vertiv s.r.l., Piove di Sacco (IT)

(72) Inventors: Wolfgang Heinzmann, Loßburg (DE); Andreas Hultsch, Neukirch (DE); Thaddäus Hinterberger, Soyen (DE); Andreas Meier, Reichertsheim (DE); Anian Richter, Munich (DE); Julius Rümelin, Munich (DE)

(21) Appl. No.: 19/182,670

(22) Filed: Apr. 18, 2025

Related U.S. Application Data
(63) Continuation of application No. PCT/EP2023/079623, filed on Oct. 24, 2023.

(30) Foreign Application Priority Data
Oct. 25, 2022 (DE) 10 2022 211 319.5

(51) Int. Cl. G05D 23/19; B23Q 11/12

(52) U.S. Cl. CPC G05D 23/1917; B23Q 11/126

(57) ABSTRACT

A method for controlling a temperature of a cooling device taking into account heating at least one machine component of a process machine during operation of the process machine is provided. The method includes ascertaining an expected thermal energy acting upon the at least one machine component within a temporal processing part of a control program that controls the operation of the process machine. The expected thermal energy is ascertained based a processing power provided within the temporal processing part for the at least one machine component. The method further includes determining a required heat dissipating capability of the cooling device for dissipating the expected thermal energy, and preconditioning the cooling device in advance in order to provide the required heat dissipating capability until the expected thermal energy acts upon the machine component.

### CROSS REFERENCE TO RELATED APPLICATIONS

This application is a continuation of International Application No. PCT/EP2023/079623 (WO 2024/089024 A1), filed on Oct. 24, 2023, and claims benefit to German Patent Application No. DE 10 2022 211 319.5, filed on Oct. 25, 2022. The aforementioned applications are hereby incorporated by reference herein.

### FIELD

Embodiments of the present invention relate to a cooling method and to a production system.

### BACKGROUND

Such production systems typically have at least one process machine having a plurality of machine components for processing a material. Typically, some of the machine components need to be cooled to prevent overheating due to material processing. It may also be necessary to cool the material to be processed or reactive materials. For this purpose, the aforementioned temperature-regulating cooling methods are carried out on the production systems.

The importance of cooling methods is increasing in particular in process machines where material processing takes place with a large amount of heat input. Classic examples of these process machines include, for example, laser processing machines.

The production system typically includes a cooling device that dissipates heat generated during material processing from the processing device. For this purpose, the processing device is usually connected to a cooling circuit with a circulating cooling fluid, e.g., cooling water. The heat of the processing device absorbed by the cooling fluid is released in the cooling device and then fed back into the processing device. Depending upon the amount of heat generated in the processing device, the cooling capacity of the cooling device can be adjusted to ensure sufficient cooling of the processing device. For this purpose, modern production systems have an interface between the processing device and the cooling device, via which information on the required cooling capacity can be exchanged. For example, the cooling water temperature, the flow rate, or the power of a cooling water pump can be specified via the interface.

Various types of cooling devices and cooling methods are known from the prior art.

For example, it is known from CN 109332888 A to determine the flow rate of the cooling fluid required for cooling a laser processing unit or the pumping power of the cooler based upon the laser power used during processing, and to specify it to a cooling device.

In addition, during processing, it is known to measure the temperature of the cooling water in the return line of the cooling circuit or the temperature of a machine component to be cooled or a material to be cooled, in order to regulate the temperature and/or the flow rate of the cooling fluid, as described, for example, in CN 110102895 A or WO 2020/096552 A2.

From DE 10 2017 206 074 A1, a laser device is known which can dissipate the heat emitted by a laser oscillator by means of a relatively small cooler. The laser device has a calculation part that ascertains a maximum temperature of the individual components of the laser device during laser processing. If the maximum temperature exceeds a limit, a warning can be issued before laser processing begins, and the production parameters can be changed if necessary.

However, the devices known from the prior art are set up to ensure sufficient cooling of the process machine only with respect to relatively constant process conditions. However, material processing on modern processing devices usually takes place under dynamic process conditions. For example, in laser processing, as an example of a dynamic material processing process, the laser power is required only for a certain period of time depending upon the processing task, is changed over a rapid period of time, or the laser is switched off during positioning operations of the machine. The same applies to the movement sequences of the mechanical components, e.g., the moving machine axes. The aforementioned processes are dynamic, and heat is generated discontinuously in the process machine.

If processing is carried out with dynamically changing process conditions, in the aforementioned examples from the prior art, the cooling device can only react with a time delay. As a result, the cooling fluid temperature in the flow of the cooling circuit can fluctuate by several degrees Celsius, which means that the resulting heat can be dissipated only inadequately. By the time the cooling device is adjusted to the changed process conditions, the temperature of a machine component may thus have already risen to an undesirable level. This can initially affect the production quality of the process machine. In more serious cases, the temperature increase leads to overheating of the machine component and can cause production downtime and/or damage to the processing equipment.

Conversely, changing process conditions may cause the set cooling capacity of the cooling device to be too high. This causes too much heat to be removed from the process machine, which can also impair the production quality. In any case, excessive cooling of the laser processing device leads to increased operating costs.

### SUMMARY

Embodiments of the present invention provide a method for controlling a temperature of a cooling device taking into account heating at least one machine component of a process machine during operation of the process machine. The method includes ascertaining an expected thermal energy acting upon the at least one machine component within a temporal processing part of a control program that controls the operation of the process machine. The expected thermal energy is ascertained based a processing power provided within the temporal processing part for the at least one machine component. The method further includes determining a required heat dissipating capability of the cooling device for dissipating the expected thermal energy, and preconditioning the cooling device in advance in order to provide the required heat dissipating capability until the expected thermal energy acts upon the machine component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic representation of a cooling method according to some embodiments;

FIG. 2 shows a control program or a control plan for processing a workpiece in conjunction with a heat dissipation plan according to some embodiments; and

FIG. 3 is a schematic representation of a production system with a process machine, a cooling device, and a machine control system, according to some embodiments.

### DETAILED DESCRIPTION

Embodiments of the present invention provide a device and a method for dynamic and energy-efficient cooling of a processing machine during material processing.

According to some embodiments, a cooling method, in particular a computer-aided one, is provided. In other words, the cooling method can be carried out at least partially using computers.

The cooling method is suitable, in particular designed, for the, in particular unidirectional, temperature control of a cooling device. The temperature control takes into account heating of at least one machine component of a process machine during operation of the process machine. The process machine can have several, in particular a large number of, machine components. The cooling method can be carried out taking into account the heating of a plurality of machine components. Preferably, the temperature control can give priority to the heating of temperature-critical machine components. The cooling method is preferably used in conjunction with dynamic material processing using high-energy processing tools. The cooling method is particularly preferably designed for use on a laser processing machine.

The cooling method is carried out using a cooling device. The cooling device is set up to absorb thermal energy from the process machine. Typically, the cooling device is fluidically coupled to the process machine via at least one cooling circuit. Typically, the process machine is cooled during material processing.

The operation of the process machine is typically controlled or predetermined by a control program. For example, the control program can provide for the production of a workpiece by laser beam cutting of a workpiece blank. During material processing, the process parameters specified in the control program can change, in particular several times, in a time-dependent manner. For example, laser power, feed rate, thermal power, actuator power, etc., may change during material processing. The change of process parameters during material processing can be understood as dynamic material processing.

The change of the process parameters is predetermined in the control program. Typically, the process machine performs material processing according to the control program. In other words, the sequence of material processing or the temporal change of the process parameters is known before the material processing is carried out.

The cooling method has at least the following method steps.

One method step involves ascertaining an expected thermal energy or heat quantity, acting upon the machine component, within a temporal processing part of the control program.

A processing part is to be understood as a subsection of the control program. The control program can have a plurality of processing parts. A processing part typically involves material processing with constant process parameters. Different processing parts can take different lengths of time.

According to some embodiments, the thermal energy is ascertained on the basis of a processing power, provided within the processing period, of the process machine. The processing power usually represents the largest proportion of the energy input. The processing power can therefore represent the substantial part of the heat input into the process machine or an individual machine component. In addition, it can be provided that further energy inputs from different machine components, e.g., drive powers of actuators, be taken into account when ascertaining the expected thermal energy. Typically, the thermal energy of a laser processing machine is ascertained based upon the laser power.

In order to be able to make an accurate prediction of the expected thermal energy, it can be provided that a processing data set be stored, having a correlation between the processing power of the process machine, in particular the laser power of the laser processing machine, and the resulting heat input into the process machine, in particular the laser processing machine. The resulting heat input can be ascertained by simulation and/or measurement technology. Preferably, the processing data set contains a plurality of resulting heat inputs for a plurality of different processing powers, in particular laser powers. Particularly preferably, a heat input for a specific processing power is based upon a large number of different simulations and/or measurements. This can increase the accuracy of the prediction.

In addition, the processing data set can take into account further processing parameters of the process machine in the correlation with the resulting thermal energy in the machine component. Additional processing parameters can have a decisive influence on the expected thermal energy. In a laser processing machine, for example, the thermal energy generated in the laser unit can be ascertained from the pumping power of the pump diodes minus the emitted laser power, plus a constant for the cooling of the control cabinet components. Furthermore, for example, in the drives for the axis movement in the laser processing machine, the thermal energy generated can be ascertained from the power loss of the drives. Furthermore, for example, the thermal energy generated at a processing head of the laser processing machine can depend upon absorption or scattering of laser radiation on optical and mechanical components of the processing head. Furthermore, for example, during laser cutting or welding, the thermal energy generated in the active components (laser diodes, optics, drives, power electronics) depends upon the length of the contour to be processed and the processing speed as well as the technology parameters (laser power, gas pressure, focus position, etc.) for the respective material to be processed.

A further method step involves determining a required heat dissipating ability of the cooling device for the processing part. The cooling device is typically designed by means of a cooling medium to dissipate or store the expected thermal energy within the duration of the processing part. Heat dissipating ability is to be understood as the general ability of the cooling device or cooling medium to absorb thermal energy. In other words, the required thermal counterbalance to the expected heat input is determined. The heat absorption capacity can be suitable for rapid absorption or for continuous absorption of thermal energy. The heat dissipating ability typically consists of a heat absorption capacity for absorbing thermal energy at the machine component through the cooling medium, a heat conduction capacity within the cooling device, a heat storage capacity of the cooling device, and a heat dissipating ability of the cooling device for dissipating the thermal energy to an environment of the cooling device. Determining the required heat dissipating ability can be understood as determining the heat absorption capacity, the heat conduction capacity, the heat storage capacity, and/or the heat dissipating ability.

For example, the cooling medium can have a cooling liquid circulating in the cooling circuit between the cooling device and the process machine and a heat sink arranged or formed on the cooling device. In this case, the heat absorption capacity can be determined by the temperature and/or the circulation rate of the cooling liquid. Furthermore, the thermal conductivity of the cooling medium can be determined by the temperature difference between the cooling liquid and the heat sink as well as the circulation speed of the cooling liquid. The thermal mass of the heat sink can also determine, for example, the heat storage capacity. The ambient temperature and/or switchable heat sinks can also determine the heat dissipating ability, for example.

The required heat dissipating ability of the cooling medium can be derived from a temperature of the machine component not increasing, in particular a maximum temperature not being exceeded, regardless of heat input.

A further method step involves preconditioning the cooling device in advance in order to provide the required heat dissipating ability until the expected thermal energy acts upon the machine component. In other words, the cooling device or the cooling medium is prepared for the expected heat input. The lead time is preferably kept long to support energy-efficient operation of the cooling device. In this case, the lead time can be several minutes, for example, to allow the cooling medium to cool down slowly. In other cases, the control program may require that the cooling device be preconditioned as quickly as possible. In this case, the lead time can be less than one minute.

In order to enable precise preconditioning of the cooling device as a function of the expected thermal energy, it can be provided that a control data set be stored with a correlation between a heat dissipating ability of the cooling device and possible control parameters of the cooling device. The control parameters of the cooling device which bring about a certain heat dissipating ability of the cooling device have preferably been ascertained by simulation and/or testing. Preferably, the control data set contains several combinations of control parameters that bring about a specific heat dissipating ability of the cooling device. Preferably, the different combinations of control parameters can be evaluated for a specific heat dissipating ability of the cooling device in terms of energy efficiency and/or delivery speed. The control data set preferably includes a plurality of resulting heat dissipating abilities for a plurality of different combinations of control parameters. Particularly preferably, a resulting heat dissipating ability for a certain combination of control parameters is based upon a plurality of different simulations and/or tests. This can increase the accuracy of the prediction.

Typical control parameters of the cooling device are, for example, a cooling capacity, a number of active compressor stages, a temperature of the cooling medium, a circulation speed of the cooling medium, an ambient temperature of the cooling device and/or the process machine, etc. The list is not intended to be exhaustive.

The control parameters can affect one or more components of the heat dissipating ability of the cooling device. Depending upon the ascertained thermal energy, optimal preconditioning of the cooling device or the cooling medium can thus be achieved.

Preferably, the cooling device is controlled in such a way that the cooling device always operates in a lowest-energy operating mode with regard to electrical power consumption. This increases the energy efficiency of the cooling device.

As described above, the cooling method according to embodiments of the invention provides for a predictive control of the cooling device. The control of the cooling device can be determined using the control program of the process machine, from which necessary changes in the cooling behavior can be derived from predetermined changes in the processing parameters. Due to the predefined material processing sequence in the control program, the cooling behavior of the cooling device can be adjusted in advance before the corresponding processing parameters are changed. The necessary change in the cooling behavior is thus completed when the processing parameters are changed, whereby any resulting thermal energy can be dissipated by the cooling device or the cooling medium. Temperature fluctuations in the cooling circuit, which can cause overheating of the machine components, can therefore be effectively prevented.

An embodiment is preferred in which the process machine is a laser processing machine, or a process machine for forming a material, or a process machine for controlling the temperature of a medium, or a process machine for electron beam processing, or a process machine for a process whose expected thermal energy is predictable within a temporal processing part of the control program.

For example, the cooling method is suitable for cooling a soldering system. The soldering system is typically designed to produce solder joints. In this case, the number of solder joints, the time interval for creating the solder joints, and/or the amount of solder to be used, can be known in advance from the control program—in this case the soldering plan. This makes it possible to ascertain the expected amount of heat at any given time and to determine the required heat dissipating ability.

Furthermore, for example, the cooling method is suitable for cooling an injection-molding system for the production of plastic parts. In this case, the amount of plastic material to be injected and the timing of the injection process can be taken from the control program. The expected thermal energy can be ascertained, and the required heat dissipating ability can be determined.

Furthermore, for example, the cooling method can be suitable for cooling a roller for extruding films. The control program typically includes the thickness, length, and material of the film, from which the expected thermal energy can be ascertained and the required heat dissipating ability can be determined.

In a preferred embodiment of the cooling method, an aging of the at least one machine component is taken into account when ascertaining the expected thermal energy. For example, aging machine components can lead to increased heat input, which requires an increased heat dissipating ability of the cooling medium. For example, it can be provided that the machine component be monitored with sensors in order to detect a change, in particular a slow change, in the age-related thermal energy.

An embodiment of the cooling method is preferred in which an expected temperature of the machine component is taken into account when determining the required heat dissipating ability. In other words, the initial temperature of the machine component is taken into account before heating by the expected thermal energy. This can be done by comparing a target temperature of the machine component with an actual temperature of the machine component. For example, it may be possible to warm up the machine component to an operating temperature. In this case, for example, the existing cooling behavior can be maintained or reduced by the cooling device.

Further preferred is an embodiment of the cooling method in which a maximum temperature of the machine component is taken into account when determining the required heat dissipating ability. In other words, the actual temperature of the machine component can be compared with a maximum temperature. From this, a temperature tolerance can be derived. For example, a low temperature tolerance can result in a prioritization of the heat absorption capacity, while a high temperature tolerance can result in a prioritization of the energy-efficient operation of the cooling device.

In a preferred embodiment of the cooling method, the ambient temperature of the laser processing machine and/or the cooling device is taken into account when determining the required heat dissipating ability. For example, the ambient temperature may be influenced as a function of the location of the process machine and/or the cooling device and/or the time of day or year, and may have different effects on the operating mode of the cooling device. For example, the heat dissipating ability of the cooling medium may be increased at low ambient temperatures, which may reduce the heat storage capacity. By taking the ambient temperature into account, the determination of the heat dissipating ability under an energetically optimal operating mode of the cooling device can be improved.

Further preferred is an embodiment of the cooling method in which a processing period of the processing part is taken into account when determining the required heat dissipating ability and/or preconditioning. In other words, the temporal duration of the processing part is taken into account. For example, an expected thermal energy within a short processing period may result in a high heat intensity, in which case the thermal energy must be dissipated over a short period of time. In this case, the heat dissipating ability can be preconditioned with respect to the heat absorption capacity. Furthermore, for example, an expected thermal energy within a long processing period can lead to a continuous heat load, wherein the thermal energy has to be dissipated over a longer period of time. In this case, the heat dissipating ability can be preconditioned with respect to the thermal conductivity. By knowing the processing time, the preconditioning can thus be adapted to the expected thermal energy, or the cooling device can be controlled accordingly. By way of example, a setting of the control parameters can provide that a high heat intensity be dissipated by briefly switching on an additional compressor stage and increasing the circulation speed of the coolant, while the other control parameters of the cooling device are kept constant. Furthermore, e.g., in the case of continuous heat load, the cooling capacity of the cooling device can be permanently increased.

In a preferred embodiment of the cooling method, the expected thermal energy and/or the heat dissipating ability of at least one processing part preceding the processing part, in particular immediately preceding it, and/or the processing part following it, in particular immediately following it, is taken into account when determining the required heat dissipating ability and/or preconditioning. This allows the cooling device to be controlled as a function of the previous and/or subsequent processing step.

For example, preconditioning of the cooling device for a processing part may be less if the expected thermal energy in the subsequent processing part is lower and causes a reduction in the heat dissipating ability.

Further preferred is an embodiment of the cooling method in which the expected thermal energy is ascertained for a plurality of temporal processing parts of the control program. In particular, the processing parts follow one another directly. This enables energy-efficient and predictive operation across a large part of the control program, in particular the entire control program.

A preferred embodiment of the cooling method provides that at least one cooling circuit and/or one compressor stage of the cooling device be switched on or off for preconditioning the cooling device. This can in particular increase the thermal conductivity and the heat storage capacity, whereby the thermal energy that can be dissipated by the cooling medium can be significantly increased.

Embodiments of the invention also provide a production system. The production system has a process machine, preferably a laser processing machine, and a temperature-controllable cooling device. The process machine comprises at least one machine component described above and below.

The production system is set up to carry out the cooling method described above and below.

For this purpose, the production system has a machine control. The machine control is designed to control and/or regulate individual machine components of the process machine and/or the cooling device. The machine control can be arranged, in particular formed, on the process machine. The machine control is also set up to carry out, i.e., to read and execute, the control program.

The machine control is preferably set up to ascertain the thermal energy acting upon the machine component. This eliminates the need to transfer the control program to another computing unit. In order to ascertain the thermal energy, the machine control can be designed to read a storage medium and a processing data set stored thereon. In particular, the machine control can be designed to ascertain the thermal energy for interpolation between the data of the processing data set.

The machine control preferably has a data interface to the cooling device. The data interface can be used to exchange instructions and/or data between the machine control and the cooling device. For example, it can be provided that the machine control transmit an ascertained expected thermal energy to the cooling device.

In a preferred embodiment of the production system, the machine control is set up to determine the required heat dissipating ability of the cooling medium. This allows essential method steps to be carried out by the machine control, which means that the cooling method can be carried out more quickly.

Furthermore, an embodiment of the production system is preferred in which the machine control is set up and/or designed to control or precondition the cooling device. In other words, the machine control can be designed to implement control parameters on the cooling device. This makes the cooling method particularly easy to apply to various cooling devices.

In a preferred embodiment of the production system, the cooling device is designed for continuously controlling a cooling capacity between zero and one hundred percent. This allows the cooling device to be preconditioned particularly precisely to the required heat dissipating ability.

Also preferred is an embodiment in which the production system has at least one controllable proportional valve for fluidically separating and/or merging at least two cooling circuits. In other words, in addition to controlling an internal cooling machine of the cooling device, the cooling device can also have controllable components in the cooling circuit. By separating and/or merging cooling circuits, a flow temperature, for example, of the cooling circuit can be preconditioned. In other words, cooling circuits with different temperatures can be mixed.

Further preferred is an embodiment of the production system in which the cooling device has at least two controllable cooling stages, at least two operating modes, at least two compressors, and/or at least one free cooler. The use of one or more additional components of the cooling device increases the possibilities for preconditioning the cooling device as a function of the expected thermal energy. This ensures energy-efficient operation.

In a preferred development of the production system, the cooling device is designed for multi-stage compression, evaporation, and liquefaction of the coolant. This can significantly increase the heat dissipating ability of the cooling medium. Preferably, in this case, the production system has water as a coolant. The inventors have found that the cooling method can be carried out with particular energy efficiency when using water. Further preferably, the cooling device is designed to carry out a cooling cycle process in a rough vacuum. This allows different operating modes to be carried out on the cooling device.

Likewise, the aforementioned features and those which are to be explained below can each be used individually or severally in expedient combinations of any kind. The embodiments shown and described are not to be understood as an exhaustive list, but, rather, have an exemplary character.

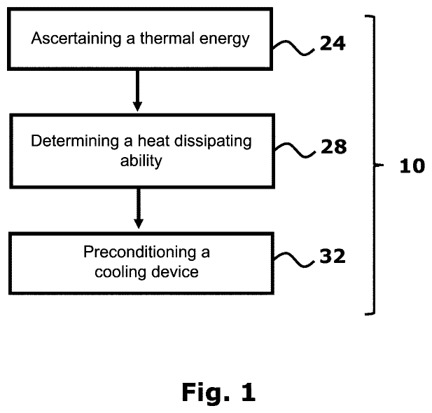

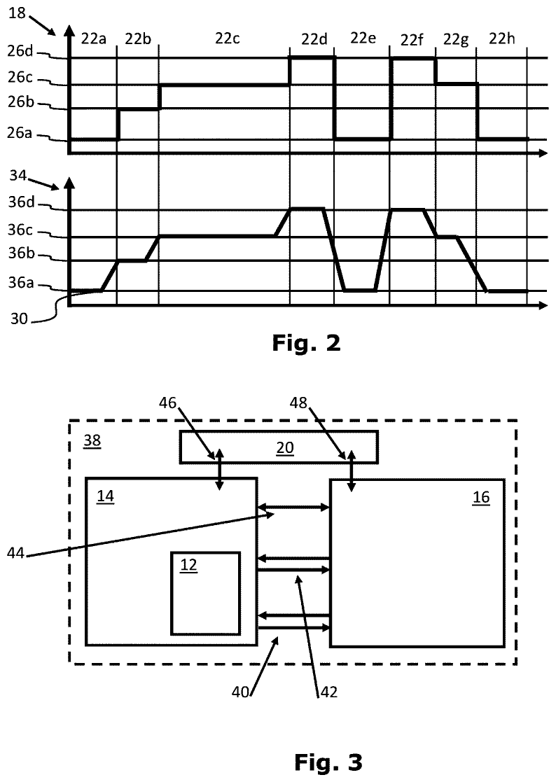

FIG. 1 schematically shows a cooling method 10 according to embodiments of the invention. The cooling method 10 is explained below with reference to FIGS. 2 and 3.

The cooling method 10 is for temperature control of a cooling device 16 (see FIG. 3). The temperature control takes into account heating of at least one machine component 12 (see FIG. 3) of a process machine 14 (see FIG. 3)—here in the form of a laser processing machine.

The cooling or heat dissipation takes place during operation of the process machine 14, typically during the processing of at least one material (not shown) by the process machine 14. The operation of the process machine 14, in particular the processing operation of the process machine 14 for processing the material, is predetermined in a control program 18 (see FIG. 2). The control program 18 is, for example, provided in a machine control 20 before material processing (see FIG. 3). The control program 18 can, as shown, have a plurality of processing parts 22a-h (see FIG. 2).

The cooling method 10 has at least the following method steps.

In a first method step 24, ascertaining an expected thermal energy or heat quantity acting upon the machine component 12 within a temporal processing part 22a-h of the control program 18 is provided. The expected thermal energy is ascertained on the basis of a processing power 26a-d (see FIG. 2)—here, a laser power—provided within the corresponding processing part 22a-h. In other words, the control program 18 can provide material processing with a different processing power 26a-d in each processing part 22a-h. Depending upon the respective processing part 22a-h, the thermal energy, resulting from the processing power 26a-d, which acts upon the machine component 12, can change dynamically.

In a further method step 28, determination of a required heat dissipating ability 30 (see FIG. 2) of a cooling medium (not shown) for dissipating the expected thermal energy is provided. Typically, the heat dissipating ability 30 is adapted to the thermal energy to be dissipated. If the heat dissipating ability 30 of the cooling medium is too great, the machine component 12 can be cooled too much and/or the operation of the cooling device 16 can become uneconomical. In contrast, if the heat dissipating ability 30 is too low, the machine component 12 may overheat and result in production failures.

A further method step 32 provides for preconditioning of the cooling device 16 in advance, in order to provide the required heat dissipating ability until the expected thermal energy acts upon the machine component 12. In other words, the heat dissipating ability 30 is adapted in advance to an expected heat input. For example, the heat dissipating ability 30 is increased or decreased. This can prevent an adjustment of the heat dissipating ability 30 in response to incoming thermal energy, thereby avoiding temperature fluctuations.

FIG. 2 shows the control program 18 for processing a material in connection with a heat dissipation plan 34.

The control program 18 has the processing parts 22a-h. The processing parts 22a-h can be designed to be chronologically successive in the control program 18. The processing parts 22a-h may have different durations. Adjacent processing parts 22a-h typically have a different processing power 26a-d, wherein the processing power 26a represents a minimum processing power 26a, and the processing power 26d represents a maximum processing power 26d. The minimum processing power 26a can be zero watts.

According to the control program 18, it can be provided that, over the course of the control program 18, the processing power 26a in the processing part 22a be gradually increased to the processing power 26b, 26c, and 26d via the processing parts 22b, 22c, and 22d. The increase in the processing power 26a-d may be necessary, for example, in connection with a feed rate of the laser during material processing. Furthermore, it can subsequently be provided that the processing power 26a-d in the processing part 22e be reduced to the minimum processing power 26a. This can happen, for example, if the position of the laser changes when it is switched off. Subsequently, it can be provided that the processing power 26a-d in the processing part 22f be increased abruptly to the maximum processing power 26d and be gradually reduced again in the subsequent processing parts 22g and 22h. In other words, the control program 18 can provide a dynamic change in the processing power 26a-d during material processing.

The cooling method 10 according to embodiments of the invention (see FIG. 1) is designed to ascertain the heat input that is dependent upon the change in the processing power 26a-d, or the thermal energy acting upon the machine component 12. Furthermore, the cooling method 10 can be designed to determine the required heat dissipating ability 30 in the respective processing part 22a-h.

The heat dissipating ability 30 determined for each processing part 22a-h can be represented by way of example in the heat dissipation plan 34 shown.

The heat dissipation plan 34 can have a profile of the heat dissipating ability 30 related to one, in particular all, processing parts 22a-h of the control program 18. The heat dissipation plan 34 can, for example, be created before material processing begins. The heat dissipation plan 34 may be provided to the process machine 14 and/or the cooling device 16, preferably by the machine control 20. Particularly preferably, the heat dissipation plan 34 is created by the machine control 20.

The heat dissipating ability 30 can have different heat dissipation levels 36a-d. The heat dissipation levels 36a-d are dependent upon the processing power 26a-d. The heat dissipation levels 36a-d may have an offset with respect to the processing power 26a-d. For example, it may be provided that the heat dissipation level 36a enable the dissipation of thermal energy, even though a correlating processing power 26a has the value of zero watts. This may be due to machine components 12 that need to be cooled even when the laser is switched off. For example, in the case of power electronics of the process machine 14.

From the change in the heat dissipating ability 30 according to the heat dissipation plan 34, it is clear that an adjustment of the heat dissipating ability 30 can be initiated in advance such that the required heat dissipating ability 30 is provided when the thermal energy caused by the respective processing power 26a-d occurs.

For example, the heat dissipating ability 30 in the processing part 22a may be increased to provide the required heat dissipation level 36b when changing the laser power 26a to the processing power 26b. This can prevent overheating of the machine component 12 or keep a temperature of the machine component 12 constant, despite additional heat input.

Furthermore, for example, the heat dissipating ability 30 in the processing part 22d can be reduced before a change in the processing power 26d to the processing power 26a, insofar as overheating of the machine component 12 can be excluded in this case. This enables energy-efficient operation.

FIG. 3 schematically shows a production system 38 with a process machine 14, a cooling device 16, and a machine control 20.

The process machine 14 can be fluidically connected to the cooling device 16 by means of at least one first cooling circuit 40. Preferably, the production system 38 has a further cooling circuit 42 which is designed for further cooling of the machine component 12.

The process machine 14 can have a data interface 44 for communication with the cooling device 16. Furthermore, the machine control 20 has at least one data interface 46 to the process machine 14 and a data interface 48 to the cooling device 16.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

cooling method 10;
machine component 12;
process machine 14;
cooling device 16;
control program 18;
machine control 20;
processing part 22a-h;
method step 24;
processing power 26a-d;
method step 28;
heat dissipating ability 30;
method step 32;
heat dissipation plan 34;
heat dissipation level 36a-d;
production system 38;
cooling circuit 40;
cooling circuit 42;
data interface 44;
data interface 46;
data interface 48.

1. A method for controlling a temperature of a cooling device taking into account heating at least one machine component of a process machine during operation of the process machine, the method comprising:
ascertaining an expected thermal energy acting upon the at least one machine component, within a temporal processing part of a control program that controls the operation of the process machine, wherein the expected thermal energy is ascertained based a processing power provided within the temporal processing part for the at least one machine component;
determining a required heat dissipating capability of the cooling device for dissipating the expected thermal energy; and
preconditioning the cooling device in advance in order to provide the required heat dissipating capability until the expected thermal energy acts upon the machine component.

2. The method according to claim 1, wherein the process machine is a laser processing machine, or a machine for forming a material, or machine for controlling a temperature of a medium, or a machine for electron beam processing, or a machine for a process whose expected thermal energy is predictable within the temporal processing part of the control program.

3. The method according to claim 1, wherein an aging of the at least one machine component is taken into account when ascertaining the expected thermal energy.

4. The method according to claim 1, wherein an expected temperature of the machine component is taken into account when determining the required heat dissipating capability.

5. The method according to claim 1, wherein a maximum temperature of the machine component is taken into account when determining the required heat dissipating capability.

6. The method according to claim 1, wherein an ambient temperature of the process machine and/or the cooling device is taken into account when determining the required heat dissipating capability.

7. The method according to claim 1, wherein a processing period of the processing part is taken into account when determining the required heat dissipating capability and/or when preconditioning the cooling device.

8. The method according to claim 1, wherein, when determining the required heat dissipating capability and/or when preconditioning the cooling device, a first expected thermal energy and/or a first required heat dissipating capability of a first processing part preceding the processing part, and/or a second expected thermal energy and/or a second required heat dissipating capability of a second processing part following the processing part are taken into account.

9. The method according to claim 1, wherein the ascertaining the expected thermal energy is carried out for a plurality of temporal processing parts of the control program.

10. The method according to claim 1, wherein, for the preconditioning the cooling device, at least one cooling circuit and/or one compressor stage of the cooling device is switched on or off.

11. A production system comprising:
a process machine comprising at least one machine component,
a temperature-controllable cooling device, and
a machine control,
wherein the production system is configured to carry out the method according to claim 1, and
wherein the machine control is configured to carry out the control program and to ascertain the thermal energy acting upon the machine component.

12. The production system according to claim 11, wherein the machine control is configured to determine the required heat dissipating capability of the cooling device.

13. The production system according to claim 11, wherein the machine control is configured to control the cooling device.

14. The production system according to claim 11, wherein the cooling device is configured to continuously control a cooling capacity between zero and one hundred percent.

15. The production system according to claim 11, further comprising at least one controllable proportional valve for fluidically separating and/or merging at least two cooling circuits.

16. The production system according to claim 11, wherein the cooling device has at least two controllable cooling stages, at least two operating modes, at least two compressors, and/or at least one free cooler.

17. The production system according to claim 16, wherein the cooling device is configured for multi-stage compression, evaporation, and liquefaction of a coolant, wherein the production system uses water as the coolant, and wherein the cooling device is configured to carry out a cooling cycle process in a rough vacuum.
